(19) United States
(12) Patent Application Publication
(10) Pub. No.: US 2006/0200545 A1
(43) Pub. Date: Sep. 7, 2006

(54) Multi-supplier multi-domain mediation element between an application service provider and resource provider in a telecommunication network

(76) Inventors: Gaêl Fromentoux, Pleumeur-Boudou (FR); Patrick Jure, Louannec (FR)

Correspondence Address: Thomas Langer;Cohen Pontani Lieberman & Pavane, Suite 1210, 551 Fifth Avenue, New York, NY, 10176, US

(21) Appl. No.: 10/547,166

(22) PCT Filed: Feb. 27, 2004
(86) PCT No.: PCT/FR04/00448

§ 371 Date: Aug. 25, 2005

(30) Foreign Application Priority Data
Feb. 28, 2003 (FR) 03/02471

(51) Int. Cl. G06F 15/173

(52) U.S. Cl. 709/224

(57) ABSTRACT

A mediation unit (2) for mediating between application service providers (1) and resource providers (3) in a telecommunications network, which mediation unit (2) comprises means for receiving a resource allocation request (a) from the service provider (1) and requesting the corresponding resource from the resource provider (3) and is characterized in that it comprises means for receiving and taking into account an acknowledgement message (c′, d′, e′, f′, g′, h′, i′, j′) from the resource provider (3) to the effect that the resource necessary for supporting the quality of service has been implemented and means for receiving resource allocation requests from an application service provider (1) and requesting corresponding resources from resource providers (3) and receives and takes into account acknowledgement messages (c′, d′, e′, f′, g′, h′, i′, j′) coming from each resource provider and sends a notification to the application service provider (1) to the effect that all of the requested resources have been implemented by the resource provider (3).

The field of the invention is telecommunications. To be more precise, the invention relates to implementing resources that are provided by resource providers to support a telecommunications service, in particular a telecommunications service with a required end-to-end quality of service.

If a client wishes to use a service offered by an application service provider with some particular quality of service, the client must at some time negotiate that quality of service. The negotiation can take various forms; for example, it might use an SIP or RTSP multimedia session negotiation application protocol or it might use a web page, in which case the protocol used is the HTTP. After a service has been contracted to a client with a particular quality of service, when the service is used the application service provider is responsible to the client for delivering the application service in accordance with the terms and conditions of the contract, in particular in respect of quality of service. The application service provider must therefore do what is necessary to provide resources that are appropriate, in particular in terms of the quality of service offered, in telecommunications networks that participate in making available resources supporting the requested application services.

The services offered to consumers are currently evolving, with the emergence of application services offering a particular quality of service. Assuring this quality of service is difficult because it necessitates a certain number of interactions between application service providers that offer a particular quality of service and resource providers that provide the resources that assure that quality of service. Supporting an application service may involve multiple players; for example, an application service provider and a plurality of resource providers may be involved in the provision of a single application service. Because of this complex interaction, a new type of provider has recently emerged that is operative between network service providers and application service providers; these are mediation service providers, also known as generic service providers, and they offer their services in particular to other service providers.

Adopting the above approach, a system for mediating between application service providers and resource providers has been proposed that focuses on the resource allocation aspects and preserves the mutual independence of application service providers and resource providers. In other words, this system merely forwards a resource request from a service provider to a resource provider.

The main drawback of a mediation system of the above kind is that mediation is restricted to the resource request; although this relieves the service of the resource allocation task, it also deprives it of all control over resource allocation.

A first objective of the invention is to provide a resource allocation system, for use by any resource provider, that enables the application service to remain independent of the resource providers, with the benefit of some certainty of obtaining the resources in question at the appropriate time.

In the context of mobile networks, the prior art provides an architectural framework (3GPP version R5) for providing resources for assuring a quality of service. However, the only services supported are mobile network services that negotiate multimedia sessions using the SIP, the resource control mechanism is an integral part of the domain of the mobile network operator, and requesting resources is always at the initiative of end users, i.e. does not provide the required independence.

Thus in the case of mobile networks, the drawbacks at present are, firstly, limitation of the mechanism to the domain of the mobile operator and to mobile network services, which use the SIP protocol for multimedia session negotiation, and, secondly, the mode of resource reservation, which is at the initiative of users rather than service providers.

Moreover, the above prior art type of mediation very often implies a player that combines the provision of resources in its network with the associated mediation in that, to allocate resources, the mediation system must have detailed information on the resources of each underlying network, which is confidential and known only to the resource provider.

The invention eliminates the above drawbacks by providing a mediation unit for mediating between an application service provider and a resource provider in a telecommunications network, which mediation unit comprises means for receiving a resource allocation request from the service provider and requesting the corresponding resource from the resource provider and is characterized in that it further comprises means for receiving and taking into account an acknowledgement message from the resource provider to the effect that the resource necessary for supporting the quality of service has been implemented and means for receiving resource allocation requests from an application service provider and requesting corresponding resources from resource providers and receives and takes into account acknowledgement messages coming from each resource provider and sends a notification to the application service provider to the effect that all of the requested resources have been implemented by the resource providers.

The invention also provides a telecommunications arrangement that comprises an application service provider, a resource provider and a mediation unit which communicates with the application server provider and the resource provider and is characterized in that the mediation unit is of the kind defined above.

The above mediation service is particularly useful for application service providers that offer application services with a particular quality of service and at present must themselves select and request resource providers, and even supervise the implementation of resources in telecommunications networks that provide adequate support for application services offered by application service providers.

The invention therefore enables a mediation service provider to supervise the implementation of resources by any resource providers, after selecting them. This implementation of resources preferably includes the allocation of resources and may also include monitoring of resources upstream and/or downstream of allocation. Offering this facility represents additional added value for the mediation service provider, which can rely on the invention to offer to application service providers a service that makes available end-to-end resources that are provided by resource providers to support a service offering a particular end-to-end quality of service.

Other features, objects and advantages of the invention will become more clearly apparent after reading the following detailed description, which is given with reference to the appended drawings, in which:

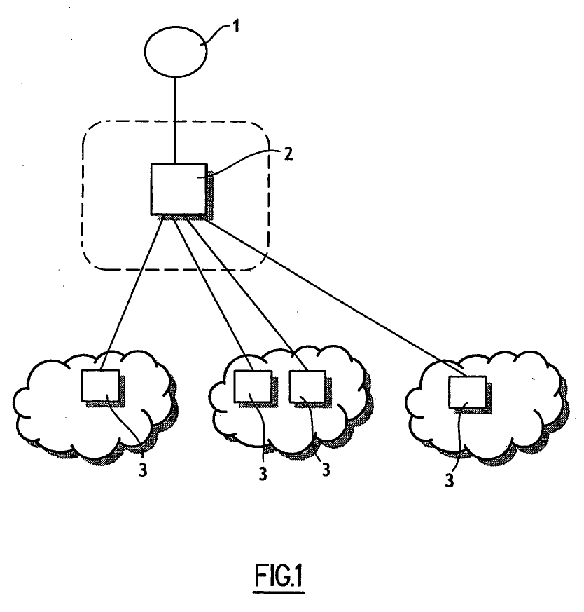

FIG. 1 represents a series of elements cooperating with each other to implement one embodiment of the invention.

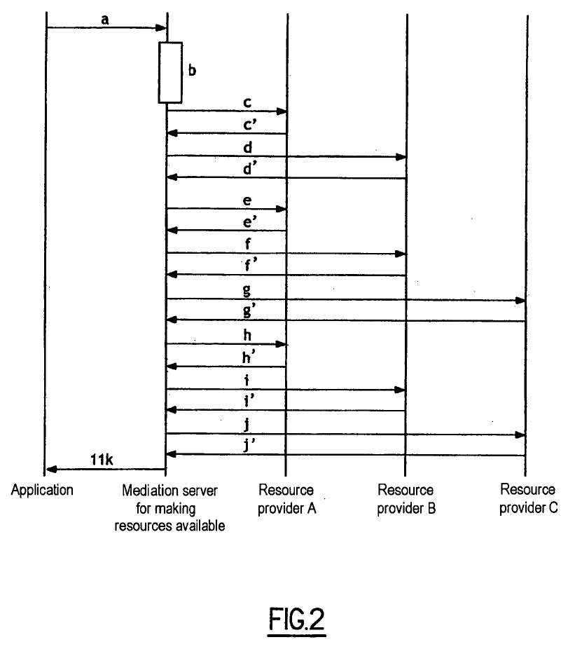

FIG. 2 is a diagram of streams exchanged between elements of a telecommunications arrangement conforming to one embodiment of the invention, in the context of an internetwork application service.

FIG. 1 shows a mediation server 2 for implementing resources that has interfaces with application service providers 1 and with one or more resource providers 3.

Herein, the expression “resource provider” refers to a physical or functional entity also known in the art as a “network service provider” and usually encountered in conjunction with application service providers. Application service providers are so called because they are physical or functional elements that process data they receive and provide processed data expressly intended for an end user.

Resource providers (network service providers) have the function of supporting and assisting transmission and transportation of data in the network.

To be more precise, the element 1 is an application that is provided by an application service provider and requires a particular end-to-end quality of service. The element 2 is a mediation server for implementing resources of a mediation service provider. The element 3 is an entity for monitoring and allocating resources provided by a resource provider. The reference number 3 is applied generically to any resource provider.

FIG. 2 represents one example of interactions between the elements of FIG. 1 and surrounding elements. The invention is described on the basis of this example.

For example, it is required to provide resources for supporting an application service between a user accessible via the access network (which is a mobile access network, for example) of an access resource provider A and another user accessible via the access network (which is an xDSL access network, for example) of an access resource provider B, which necessitates use of the core network (for example an IP backbone) of a core resource provider C.

In a step a), the application requests the mediation server for implementing resources to provide its support service, and in particular identifies the users to be connected and supplies a description of the required quality of service. In the present example the word “user” is to be understood in a wide sense in that it does not always refer to an end user; a “user” might be a server, for example.

In a step b), the mediation server for implementing resources establishes a list of resource providers that will be used to support the application service and assure the quality of service of multimedia sessions established between users. The process of selecting providers is not described here. The mediation server for making resources available also defines the quality of service information that it has to supply to each selected resource provider.

In a step c), the mediation server for implementing resources contacts the resource provider A in order to supply it with the information necessary for the resource provider A to implement resources in its network in a second phase. The message c′) is a positive acknowledgement message and may contain other information that may be necessary in subsequent phases.

In a step d), the interactions are the same as in the step c), but this time with the resource provider B. In the present example, the phase of providing information for authorization of the network service is not necessary for making resources available in the network of the resource provider C.

In a step e), if the mediation server for implementing resources is certain that all the resource providers involved are now ready to receive a request to provide resources, it requests the provision of those resources, in this example from the resource provider A. The precise protocol used between the two entities is not described in detail and depends in particular on the functions supported by each resource provider and the protocols used, which may be different.

For example, e′) is a message indicating successful provision of resources; there are other messages for indicating refusal of reservation (invalid request, no resource available in the network at the given time, etc.).

In a step f), the interactions are the same as in the step e), but this time with the resource provider B.

In a step g), the interactions are also the same as in the step e), but this time with the resource provider C.

In a step h), the mediation server for implementing resources receives confirmation from each resource provider involved that the necessary resources for supporting the requested quality of service have been implemented, in the form of acknowledgement (agreement, confirmation) messages that it has requested each resource provider to send it.

It then validates the requests, which indicates to the resource providers that the servers can now use the resources made available.

FIG. 2 shows validation of the resources of the resource provider A. The precise protocol used between the two entities is not described in detail. For example, a step g′) confirms validation of the resources of the resource provider A.

In a step i), the interactions are the same as in the step g), but this time with the resource provider B.

In a step j), the interactions are also the same as in the step g), but this time with the resource provider C.

In a step k), the mediation server for implementing resources notifies the application that the resources corresponding to the end-to-end quality of service requested by the application have been implemented and that the service may now be executed.

Note that, in the present example, the protocol and the functional content may be different, as a function of the resource providers contacted by the mediation server for implementing resources. It is possible for certain resource providers to support only two phases for implementing resources, for example only the reservation and validation phases of the above example. The mediation server for implementing resources is then able to adapt to these configurations.

The mediation server for implementing resources supports the single interface with the applications of the application service providers. It manages end-to-end quality of service requests and can identify and authenticate client service providers. A subscription phase may precede an actual request for service. The server for monitoring and allocating resources uses the client information for billing and request tracking purposes. The mediation server informs the client service providers of the progress of the requested service.

Following an end-to-end quality of service request, the mediation server uses an internal procedure to define the resource providers that will participate in making the end-to-end service available. It can also translate end-to-end service requests into a form adapted to each participating resource provider.

The mediation server interfaces with resource providers and supports various types of protocol, of greater or lesser functionality (resource providers do not all support the same procedure for implementing resources in their network).

It implements a “send information to resource providers for authorization of the network service” sequence followed by a “network service request to resource providers” sequence followed by a “validation of network service requests” sequence. It knows how to adapt to the various situations that may arise during one of these sequences (refusal of authorization by a resource provider, failure of reservation of resources of a resource provider, etc.). This may necessitate additional exchanges with the requesting application service provider in order to keep it up to date on the situation and where appropriate to request it to modify its request.

Before this, further functions preferably match the application service to end-to-end network support and identification of resource providers liable to contribute to providing support for the end-to-end application service.

This embodiment therefore corresponds to a multidomain multiprovider mediation server for implementing end-to-end resources necessary to support application services with a quality of service offered by telecommunications service providers.

More generally, and without a plurality of networks necessarily being involved, the result obtained enables a mediation service provider supporting a system to offer application service providers a service for monitoring and allocating resources to support a requested end-to-end quality of service. Thanks to the present invention, application service providers simply request a mediation service provider supporting the present invention to make available end-to-end resources to support the application service with the quality of service to which their client has subscribed, and in return, if everything has gone correctly, the mediation service provider assures them that everything is ready in the networks that will support the application service to assure the requested quality of service. In the event that it is impossible to make available the resources necessary for the application service, for example if a resource provider indispensable to the provision of end-to-end network support is incapable of providing the appropriate network service, the mediation service provider also indicates that failure to the service provider.

Note that the various application service or network service providers can all belong to the same domain or to different domains.

The invention therefore finds an application in a multidomain context, in which it enables an application service provider 1 to access a plurality of domains thanks to unified and efficient mediation.

The term “multidomain” is used in this context because the domains are different because the service providers 1, 2 and 3 belong to different commercial players, for example different telephone operators or different content provider entities.

1. A mediation unit (2) for mediating between an application service provider (1) and a resource provider (3) in a telecommunications network, which mediation unit (2) comprises means for receiving a resource allocation request (a) from the service provider (1) and requesting the corresponding resource from the resource provider (3) and is characterized in that it further comprises means for receiving and taking into account an acknowledgement message (c′, d′, e′, f′, g′, h′, i′, j′) from the resource provider (3) to the effect that the resource necessary for supporting the quality of service has been implemented and means for receiving resource allocation requests from an application service provider (1) and requesting corresponding resources from resource providers (3) and receives and takes into account acknowledgement messages (c′, d′, e′, f′, g′, h′, i′, j′) coming from each resource provider and sends a notification to the application service provider (1) to the effect that all of the requested resources have been implemented by the resource providers (3).

2. A mediation unit (2) according to claim 1, wherein it includes means for sending a notification to the application service provider (1) to the effect that the requested resource (3) has been implemented by the resource provider (3).

3. A mediation unit (2) according to claim 1, wherein the mediation unit sends the resource provider (3) two or more successive messages (c′, d′, e′, f′, g′, h′, i′, j′) corresponding to two or more steps required by the resource provider (3) to implement the resource or resources.

4. A mediation unit (2) according to claim 3, wherein the mediation unit sends the resource provider (3) three successive messages (c, e, h, d, f, I, g, j) required by the resource provider (3) for implementing the resource (3, the third message (i) validating the first two messages (d, f).

5. A mediation unit (2) according to claim 3, wherein the mediation unit monitors and acquires a positive acknowledgement message (c′, d′, e′, f′, g′, h′, i′, j′) from the resource provider in response to one of the successive resource request messages (c, d, e, f, g, h, i, j).

6. A mediation unit according to claim 1, wherein the mediation unit identifies a failure to obtain resources from a resource provider (3) and sends a message notifying said failure to the application service provider (1).

7. A mediation unit (2) according to claim 1, wherein the mediation unit includes means for identifying resource providers able to provide the specified resource(s) as function of a resource request received from the application service provider (1) and for sending the identified resource providers the resource request message(s) (c, d, e, f, g, h, i, j).

8. A telecommunications arrangement comprising an application service provider (1), a resource provider (3) and a mediation unit (2) adapted to communicate with the application server provider (1) and the resource provider (3), characterized in that the mediation unit (2) is a mediation unit according to claim 1.

9. A telecommunications arrangement according to claim 8, characterized in that the application service provider (1) provides a service between a terminal user accessible via a first access network and a terminal user accessible via a second access network which is different from the first access network because communication between the two users necessitates the use of a third network associated with a resource provider, the mediation unit advising the application service provider (1) of the obtaining of a resource of said resource provider (3) associated with the third network.

10. A telecommunications arrangement according to claim 9, characterized in that the mediation unit (2) requests a resource from a resource provider (3) belonging to the first network and from a resource provider (3) belonging to the second network, requests an acknowledgement message from each of the resource providers (3), and sends a notification message to the application service provider (1) indicating the obtaining of resources from the resource providers (3) of the three networks.
